(19) United States
(12) Patent Application Publication
(10) Pub. No.: US 2016/0269789 A1
(43) Pub. Date: Sep. 15, 2016

(54) PORTABLE COMMUNICATION SET TOP BOX SYSTEM

(71) Applicant: LIEN-TSUNG LI, Taichung City (TW)

(72) Inventor: LIEN-TSUNG LI, Taichung City (TW)

(21) Appl. No.: 14/643,888

(22) Filed: Mar. 10, 2015

(51) Int. Cl. H04N 21/4788; H04N 7/14; H04N 21/4223; H04N 7/15; H04N 21/41; H04N 21/4363

(52) U.S. Cl. CPC H04N 21/4788; H04N 21/4122; H04N 21/43635; H04N 21/4223; H04N 7/15; H04N 7/148

(57) ABSTRACT

A portable communication set top box system is provided, including a set top box device, a display device and a communication device. The set top box device includes a circuit member, a transmission portion, a first wireless device, a control module and a telecommunication connection portion. The telecommunication connection portion is for connecting with at least one outside telecommunication system. The display device is connected with the transmission portion. The communication device includes a second wireless device. The first and second wireless devices are in communication with each other through a wireless signal. The communication device includes a dial portion, a voice sending portion and a voice receiving portion. Wherein when the telecommunication connection portion receives an incoming call signal or the communication device forwards a dial signal, the control module controls the communication device and the display device to be selectively on.

### BACKGROUND OF THE INVENTION

1. Field of the Invention

The present invention relates to a communication device, and more particularly to a portable communication set top box system.

2. Description of the Prior Art

It is ordinary for a wireless communication device to be used to receive a signal from other electrical devices. For example, the wireless communication device can be used to receive a phone call or to play music.

However, the wireless communication device can be only used in voice communication and cannot be used in video communication. Furthermore, a multi-communication is usually used in a conference, and switching or dialing is also necessary. It is needed to have a device which can perform a real-time video communication and also has functions of quick dial and switching to establish a multi-communication connection in the conference.

The present invention has arisen to mitigate and/or obviate the afore-described disadvantages.

### SUMMARY OF THE INVENTION

The primary object of the present invention is to provide a portable communication set top box system which can be connected to a telecommunication system and performs real-time communication. A video communication connection is conveniently established by using a wireless communication device and a display device. An integrated set top box device further includes functions of quick dial and switching so that it has higher efficiency for a user to use and can switch to a number or establish a multi-communication connection in a conference. It can be widely applied and has high efficiency.

To achieve the above object, a portable communication set top box system is provided, including a set top box device, a display device and a communication device. The set top box device includes a circuit member, a transmission portion and a first wireless device. The circuit member is electrically connected with the transmission portion and the first wireless device. The set top box device further includes a telecommunication connection portion electrically connected with the circuit member. The telecommunication connection portion is for connecting with at least one outside telecommunication system. The set top box device further includes a control module disposed on the circuit member. The display device is connected with the transmission portion of the set top box device. The communication device includes a second wireless device. The first and second wireless devices are in communication with each other through a wireless signal. The communication device includes a dial portion, a voice sending portion and a voice receiving portion. Wherein when the telecommunication connection portion receives an incoming call signal or the communication device forwards a dial signal to the set top box device and transmits the dial signal to the telecommunication system via the telecommunication connection portion, the control module controls the communication device according to the wireless signal to selectively produce a voice signal, and the control module controls the display device via the transmission portion to selectively display a video signal.

### BRIEF DESCRIPTION OF THE DRAWINGS

FIG. 1 is a perspective drawing of a preferable embodiment of the present invention;

FIG. 2 is a partial perspective drawing of a set top box device in the preferable embodiment of the present invention;

FIG. 3 is a perspective drawing of a communication device in the preferable embodiment of the present invention;

FIG. 4 is a flow chart drawing of the preferable embodiment of the present invention; and

FIG. 5 is another flow chart drawing of the preferable embodiment of the present invention.

### DETAILED DESCRIPTION OF THE PREFERRED EMBODIMENTS

The present invention will be clearer from the following description when viewed together with the accompanying drawings, which show, for purpose of illustrations only, the preferred embodiment in accordance with the present invention.

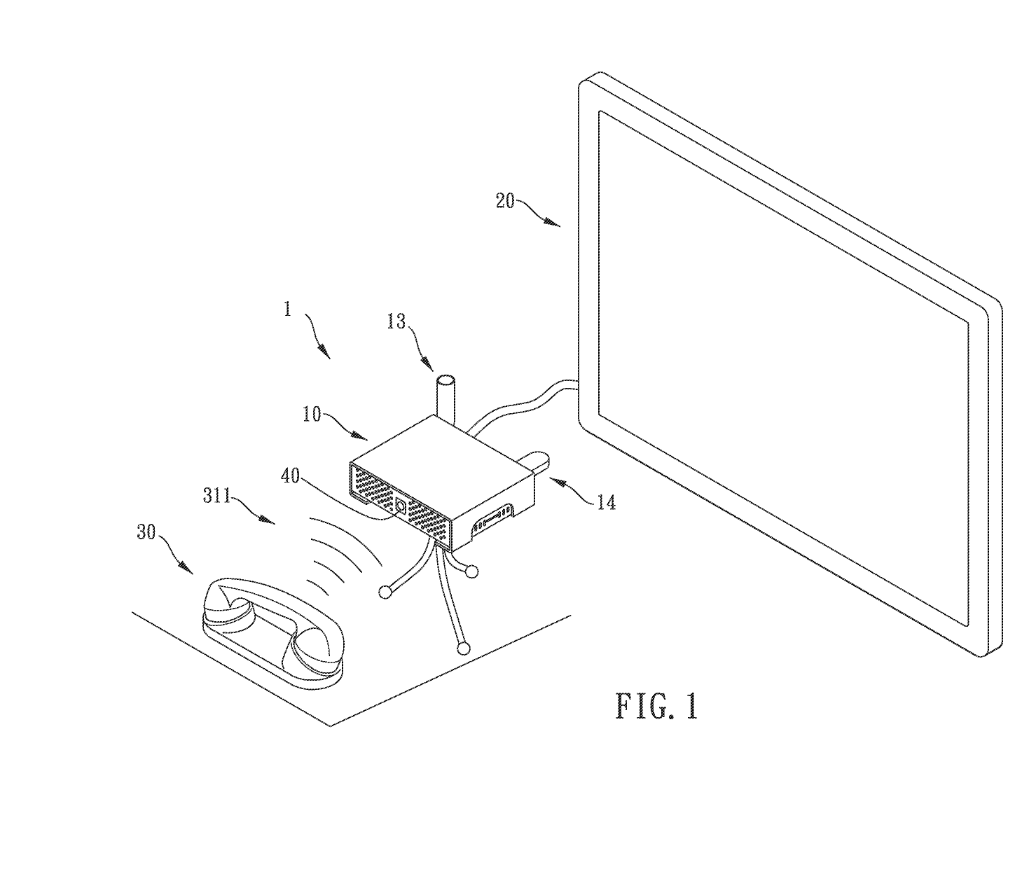

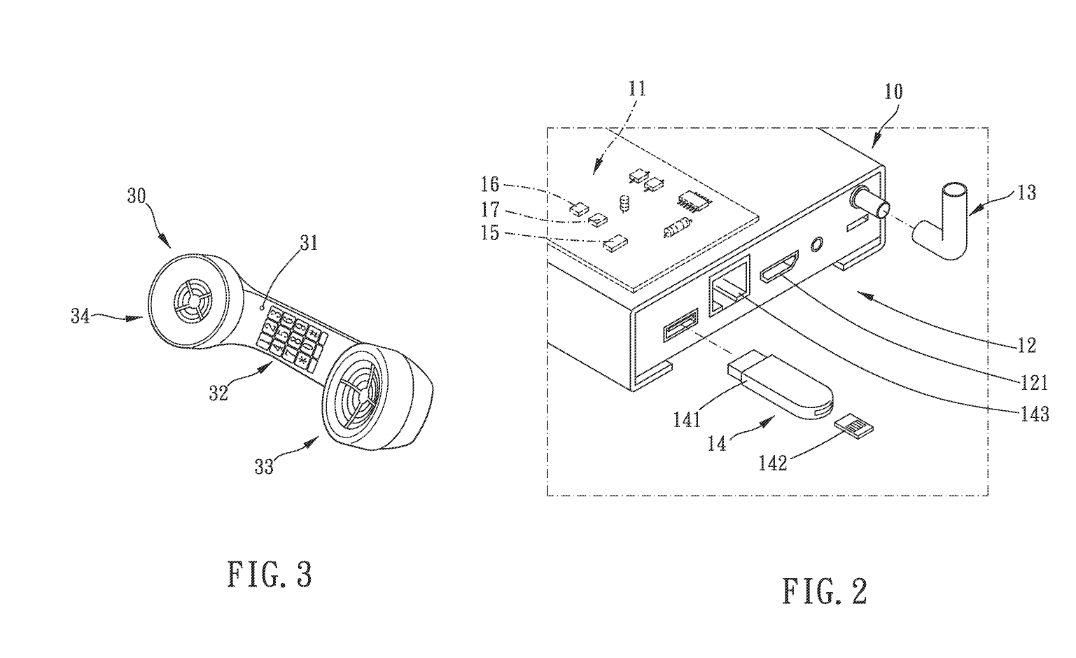

Referring to FIGS. 1-3, a portable communication set top box system 1 in accordance with a preferred embodiment of the present invention includes a set top box device 10, a display device 20 and a communication device 30.

The set top box device 10 includes a circuit member 11, a transmission portion 12 and a first wireless device 13. The circuit member 11 is electrically connected with the transmission portion 12 and the first wireless device 13. For example, the set top box device 10 is internally provided with the circuit member 11, and the circuit member 11 includes a plurality of electrical parts which are formed to be a logic electrical loop having a specific function. At least one side of the set top box device 10 is provided with the transmission portion 12 and the first wireless device 13. The set top box device 10 further includes a telecommunication connection portion 14 electrically connected with the circuit member 11. The telecommunication connection portion 14 is for connecting with at least one outside telecommunication system. Furthermore, the telecommunication connection portion 14 is for connecting to at least one of a mobile phone network, an interoffice phone network and an Internet phone network.

Moreover, the telecommunication connection portion 14 includes a connection device 141, and the connection device 141 is for a subscriber identification module (SIM) card 142 to be inserted therein. The subscriber identification module (SIM) card 142 is for people to use and for identifying a number of the telecommunication system. The connection device 141 is for reading the subscriber identification module (SIM) card 142, and the telecommunication connection portion 14 is connected to the telecommunication system via the connection device 141 so that the set top box device 10 can work with connecting or communicating functions (such as an Internet connection, a phone communication or a video communication) provided by the telecommunication system. Nevertheless, the telecommunication connection portion 14 can further include a network port, and the network port is for a network cable to connect thereto so that the set top box device 10 can directly connect to a network via the network cable.

The display device 20 is connected with the transmission portion 12 of the set top box device 10. For example, the display device 20 can be a liquid crystal display (LCD), a projection display, a plasma display panel (PDP) or other devices. The transmission portion 12 can include a HDMI connection port 121, and the display device 20 can be electrically connected with the set top box device 10 via the HDMI connection port 121 so that the display device 20 can display a video signal in the video communication.

The communication device 30 includes a second wireless device 31. The first and second wireless devices 13, 31 are in communication with each other through a wireless signal 311. For example, the first and second wireless devices 13, 31 are Bluetooth wireless devices so that the first and second wireless devices 13, 31 can be in communication with each other by using a Bluetooth wireless signal. Furthermore, the communication device 30 includes a dial portion 32, a voice sending portion 33 and a voice receiving portion 34. A user can forward a voice signal via the voice sending portion 33 and transmit the voice signal to the set top box device 10 via the wireless signal 311. The set top box device 10 transmits the voice signal to outside (such as Internet or telecommunication system) via the telecommunication connection portion 14. Furthermore, the voice signal from outside can also be transmitted to the set top box device 10 via the telecommunication connection portion 14 and be transmitted to the communication device 30 via the wireless signal 311. The user can receive the voice signal from outside via the voice receiving portion 34.

The set top box device 10 further includes a control module 15 disposed on the circuit member 11. When the telecommunication connection portion 14 receives an incoming call signal from the telecommunication system or the communication device 30 forwards a dial signal to the set top box device 10 and transmits the dial signal to the telecommunication system via the telecommunication connection portion 14, the control module 15 controls the communication device 30 according to the wireless signal 311 to selectively produce a voice signal, and the control module 15 controls the display device 20 via the transmission portion 12 to selectively display a video signal. Specifically, the control module 15 can selectively turn on the communication device 30 and the display device 20 according to the incoming call signal or the dial signal. For example, when the incoming call signal or the dial signal is a video communication signal, the control module 15 controls the communication device 30 and the display device 20 to be on so that the user can receive the voice signal and the video signal; when the incoming call signal or the dial signal is only a voice communication signal, the control module 15 controls the communication device 30 and the display device 20 to be respectively turned on and turned off Furthermore, the set top box device 10 further includes an image capture device 40. The image capture device 40 is electrically connected with the circuit member 11, and the control module 15 controls the image capture device 40 to be selectively on. For example, when the incoming call signal or the dial signal is the video communication signal, the control module 15 controls the image capture device 40 to be turned on and the image capture device 40 can capture an image of the user so that another user on another end can receive the image. However, in other embodiments, the image capture device 40 can also be disposed on the display device 20 to achieve a function as described above.

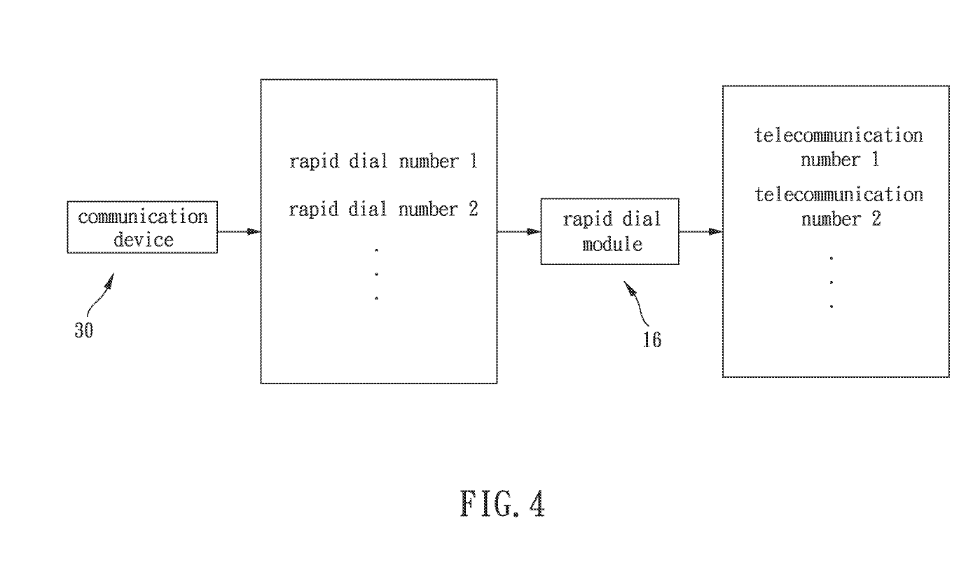

Please further refer to FIG. 4, the circuit member 11 further includes a quick dial module 16. At least one quick dial number is saved in the quick dial module 16, and the quick dial number dialed on the dial portion 32 of the communication device 30 is for connecting with a corresponding telecommunication number of the telecommunication system. For example, the quick dial number can be a set of number (such as 1, 12, 123 and so on). The quick dial number corresponds to the telecommunication number of the telecommunication system. When the user dials the quick dial number on the dial portion 32 of the communication device 30 and transmits the quick dial number to the set top box device 10 via the wireless signal 311, the quick dial module 16 transforms the quick dial number into the corresponding telecommunication number of the telecommunication system and the telecommunication number is forwarded to the telecommunication system via the telecommunication connection portion 14 so that a phone communication connection is established via the telecommunication number.

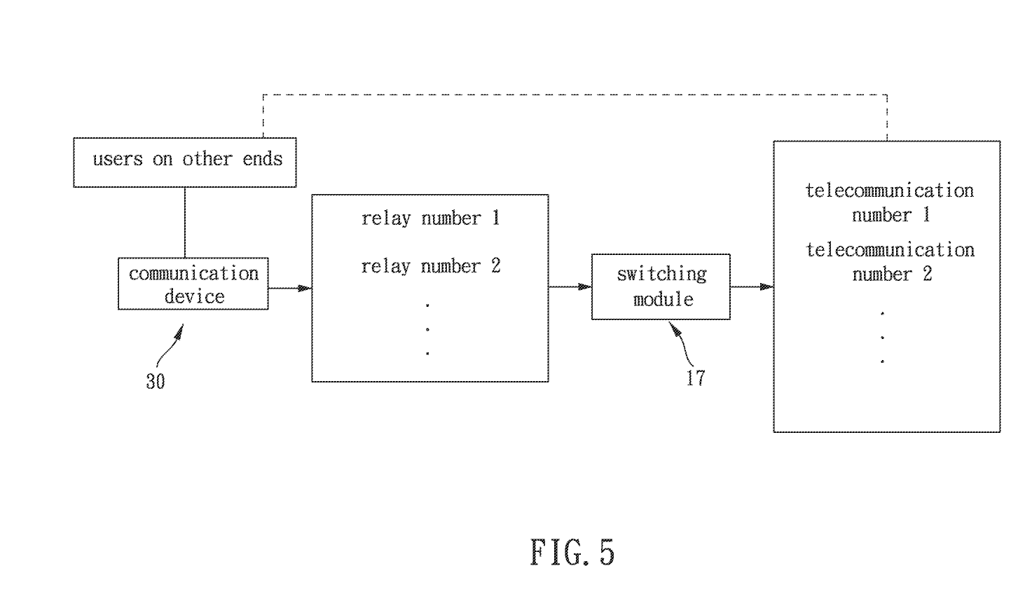

Please further refer to FIG. 5, the circuit member 11 further includes a switching module 17. At least one relay number is saved in the switching module 17, and the relay number dialed on the dial portion 32 of the communication device 30 is for connecting the incoming call signal with a corresponding telecommunication number of the telecommunication system. The relay number can be a set of number as described above and is also corresponded to the predetermined telecommunication number of the telecommunication system. When the user is communicated with the other user on the other end, the user can dial the relay number on the dial portion 32 of the communication device 30 and transmits the relay number to the set top box device 10 via the wireless signal 311. The switching module 17 transforms the relay number into the corresponding telecommunication number and transmits the telecommunication number to the telecommunication system via the telecommunication connection portion 14 so that a phone communication connection is established between the other user on the other end and the telecommunication number. It is noted that when the user is communicated with the other user on the other end, a triple-communication connection can be established between the user, the other user and the telecommunication number by a method using the switching module 17 to connect with the telecommunication number as described above. Furthermore, a multi-communication connection can also be established by using the switching module 17.

As a conclusion, the portable communication set top box system of the present invention can be connected to the telecommunication system and performs real-time communication. The video communication connection is conveniently established by using the wireless communication device and the display device. The integrated set top box device further includes functions of quick dial and switching so that it has higher efficiency for the user to use and can switch to a number or establish a multi-communication connection during a conference. It can be widely applied and has high efficiency.

While we have shown and described various embodiments in accordance with the present invention, it should be clear to those skilled in the art that further embodiments may be made without departing from the scope of the present invention.

What is claimed is:

1. A portable communication set top box system, comprising:
a set top box device, including a circuit member, a transmission portion and a first wireless device, the circuit member electrically connected with the transmission portion and the first wireless device, the set top box device further including a telecommunication connection portion electrically connected with the circuit member, the telecommunication connection portion for connecting with at least one outside telecommunication system, the set top box device further including a control module disposed on the circuit member;
a display device, connected with the transmission portion of the set top box device;
a communication device, including a second wireless device, the first and second wireless devices being in communication with each other through a wireless signal, the communication device including a dial portion, a voice sending portion and a voice receiving portion;
wherein when the telecommunication connection portion receives an incoming call signal or the communication device forwards a dial signal to the set top box device and transmits the dial signal to the telecommunication system via the telecommunication connection portion, the control module controls the communication device according to the wireless signal to selectively produce a voice signal, and the control module controls the display device via the transmission portion to selectively display a video signal.

2. The portable communication set top box system as claimed in claim 1, wherein the circuit member further includes a quick dial module, at least one quick dial number is saved in the quick dial module, and the quick dial number dialed on the dial portion of the communication device is for connecting with a corresponding telecommunication number of the telecommunication system.

3. The portable communication set top box system as claimed in claim 1, wherein the circuit member further includes a switching module, at least one relay number is saved in the switching module, and the relay number dialed on the dial portion of the communication device is for connecting the incoming call signal with a corresponding telecommunication number of the telecommunication system.

4. The portable communication set top box system as claimed in claim 1, wherein the telecommunication connection portion is for connecting with at least one of a mobile phone network, an interoffice phone network and an Internet phone network.

5. The portable communication set top box system as claimed in claim 1, wherein the telecommunication connection portion includes a connection device, and the connection device is for a subscriber identification module (SIM) card to be inserted therein.

6. The portable communication set top box system as claimed in claim 1, wherein the telecommunication connection portion includes a network port, and the network port is for a network cable to connect thereto.

7. The portable communication set top box system as claimed in claim 1, wherein the first and second wireless devices are Bluetooth wireless devices.

8. The portable communication set top box system as claimed in claim 1, wherein the display device is a liquid crystal display (LCD), a projection display or a plasma display panel (PDP).

9. The portable communication set top box system as claimed in claim 1, wherein the transmission portion includes a HDMI connection port, and the display device is electrically connected with the HDMI connection port.

10. The portable communication set top box system as claimed in claim 1, wherein the set top box device includes an image capture device, the image capture device is electrically connected with the circuit member, and the control module controls the image capture device to be selectively on.
